(19) United States
(12) Patent Application Publication
(10) Pub. No.: US 2004/0050115 A1
(43) Pub. Date: Mar. 18, 2004

(54) Optical fiber drawing apparatus for decreasing an optical fiber break and impressing a spin to an optical fiber

(75) Inventors: Joon Keun Lee, Seoul (KR); Weon Bae Kim, Suwon-si (KR); Chul Min Kim, Suwon-Si (KR)

Correspondence Address: RICHARD M. GOLDBERG, 25 EAST SALEM SREEET, SUITE 419, HACKENSACK, NJ, 07601, US

(73) Assignee: LG Cable Ltd., Seoul (KR)

(21) Appl. No.: 10/657,627

(22) Filed: Sep. 8, 2003

(30) Foreign Application Priority Data
Sep. 12, 2002 (KR) 10-2002-0055231

(51) Int. Cl. C03B 37/07

(52) U.S. Cl. 65/491; 65/504

(57) ABSTRACT

In an optical fiber drawing apparatus capable of drawing one piece of an optical fiber, the present invention provides an optical fiber drawing apparatus which is adapted to decrease a break of an optical fiber to be adjusted a curvature radius thereof by at least one or more moving rollers continuously installed after a fixing roller and to decrease a polarization mode dispersion (PMD) by a birefringence which is not desired in an optical fiber.

### BACKGROUND OF THE INVENTION

1. Field of the Invention

The present invention relates to an optical fiber drawing apparatus for decreasing an optical fiber break by adjusting a curvature radius and impressing a spin to an optical fiber, and in particular to an optical fiber drawing apparatus which it is possible to decrease an optical fiber break by continuously installing at least one or more moving rollers after a fixed roller and adjusting a curvature radius of an optical fiber and to provide a spin to an optical fiber by vertically reciprocating at least one roller among a plurality of moving rollers with respect to an optical fiber drawing surface.

2. Description of the Background Art

A process for fabricating a piece of an optical fiber is formed of an optical fiber mother material fabrication process, and a drawing process for drawing an optical fiber from the fabricated mother material.

In more detail, the optical fiber is fabricated by an optical fiber mother fabrication method such as a Modified Chemical Vapor Deposition (MCVD), an Outside Vapor Deposition (OVD) or a Vapor Axial Deposition (VAD).

The fabricated mother material is processed through the drawing process of FIG. 1. As shown in FIG. 1, the optical fiber is processed through a heating furnace 2, a diameter measuring unit 3, a cooling apparatus 4, a coating apparatus 5, an infrared ray hardening apparatus 6, and a fixing roller unit 7 which are sequentially vertically installed in an optical fiber drawing direction.

The heating furnace 2 adapted as a heat source may be formed of one of an electric resistance furnace, a high frequency induction furnace or a carbon dioxide laser. The heating furnace 2 is movable upward or downward. The optical fiber mother material melted to a desired temperature by the heating furnace 2 is drawn to one piece of an optical fiber. At this time, the inner portions of the heating furnace maintain clean so that the surface of the optical fiber 1 is not polluted by a certain impurity, and that the strength of the same is not decreased.

The diameter measuring device 3 like a laser micro measuring unit is directed to continuously measuring the diameter during the drawing operation, and a capstan(not shown) controlled at a certain speed controls the measured diameter for thereby producing an optical fiber having a desired diameter.

The optical fiber is processed through the cooling apparatus 4 for thereby implementing a certain temperature proper for a coating process. The optical fiber is processed through the cooling apparatus 4 and is coated by the coating apparatus 5. The above coating process is performed for protecting the optical fiber 1 from a moisture, friction, etc. Here, the coating material is a Kynar, an epoxy, a silicon RTV, an ultraviolet ray setting resin, etc.

Passing through the violet ray hardening apparatus 6 after being coated, the optical fiber is hardened. The optical fiber is passed through a capstan(not shown) adapted to apply a certain tensile force so that the optical fiber is drawn with a particular diameter after the optical fiber is passed through the violet ray hardening apparatus 6. Thereafter, the optical fiber is wound onto a spool (not shown) or a take-up reel (not shown).

The fabricated optical fibers are tested by a prove-test for checking whether they satisfy a minimum tension standard. The above test is performed while the optical fibers are being wound after being coated or the test is independently performed after the drawing process.

FIG. 2 is a view illustrating a fixing roller unit of a conventional optical fiber drawing apparatus. As shown in FIG. 2, the fixing roller unit 7 includes a fixing roller 7-1 for changing the direction of the optical fiber 1, and a plurality of vertical drawing rollers 7-2 for implementing a smooth drawing operation of the optical fiber 1. In the conventional optical fiber drawing apparatus which has only a fixing roller unit 7 of FIG. 2, a roller having a smaller radius is used for obtaining a certain installation space because the space is limited. In this case, the direction is hastily changed, so that a tension force and bending stress (applied by a certain rotating member having a certain radius like a roller) are generated.

A micro particle 1-1 or a crack 1-2 may occur by a local bending and a torsion stress which are applied between the vertical drawing rollers 7-2 while the optical fiber is processed through the vertical drawing rollers 7-2. If the micro particle 1-1 or the crack 12 occurs before the optical fiber passes through the fixing roller 7-1, while the optical fiber passes through the fixing roller 7-1 the stress is concentrated at the portion where the micro particle 1-1 or the crack 1-2 occurs.

The bending stress due to the roller and the stress concentrations due to the micro particle 1-1 and the crack 1-2 are known as a major factor which causes a break during an optical fiber drawing process.

The inventors of the present invention disclosed that a safety factor by the stress applied to the optical fiber 1 is generally more than 10 by a pure torsion force and a bending stress as a result of the tests. But the inventors disclosed that the safety factor can be decreased to less than 1 by a certain external environment like the micro particle 1-1, the crack 1-2 or other factors such as a vibration, so that a break may occur.

For example, assuming that the diameter of the optical fiber 1 is 125 μm, and the axial force (applied by the torsion force in the axial direction) is 0.3 kgf, the safety factor is about 18.86 because the fracture stress is 651.4 ksi without consideration of the safety factor crack, and the axial stress is 34.53 ksi(2.40×10⁸ Pa) calculated by ρ_{q}=F/A=0.3×9.81/[(π/4)×(125×10⁻⁶)²].

In addition, the safety factor determined by both the axial stress and the bending stress applied due to the roller is about 11 because the fracture stress is 651.4 ksi without consideration of the safety factor crack, the bending stress is 23.2 ksi(1.61×10⁸ Pa) calculated by ρ_{b}=Ey/R=3×70×10⁹×125×10⁻⁶/(2×0.082).

As described above, in the case that the stress concentration is not applied by the crack in the optical fiber, the safety factor by the axial stress and the bending stress applied to the optical fiber is above 10.

However, when the stress concentration by the crack is considered, the concentration stress based on the coefficient by the size and shape of the crack is 341 ksi as ρ_{c}=YK\sqrt{C}, if crack is 1 μm, the shape coefficient Y is 3, and the fracture toughness K is 0.79×10⁶.

Therefore, when the stresses due to the torsion, bending and crack which occur by one roller are combined, the safety factor may be decreased to 1.6 by the size and shape of the crack and the concentration of the stress. In addition, the safety factor may be decreased to less than 1 based on the size and number of the rollers, so that a break may occur.

Even though the break does not occur during the drawing process, when the optical fiber receives a big stress in a state that the optical fiber is not fully hardened while the optical fiber passes through the violet ray hardening apparatus 6, the optical fiber 1 may have a large damage.

The optical fiber drawing apparatus having only the fixing roller unit 7 directly transfers the vibration of the fixing roller unit 7 to an optical fiber and a drawing tower during the optical fiber drawing process, so the quality of the optical fiber may be degraded.

A preferred single mode optical fiber in a symmetrical circular shape is adapted to transfer light to two independent orthogonal polarizing modes. However, when an asymmetrical lateral stress which affects a desired circular symmetrical shape is applied to the single mode optical fiber, the above two independent orthogonal polarizing modes are transferred at different phase rates, so that a birefringence occurs. A undesired birefringence may cause a dispersion of an optical signal transferred through the optical fiber, namely, a polarization mode dispersion (PMD), so that an accuracy of a signal is decreased. Therefore, it is needed to decrease the polarization mode dispersion in the optical fiber. It is known that it is possible to decrease the polarization mode dispersion by impressing a spin to the optical fiber. In order to decrease the polarization mode dispersion phenomenon, the techniques for impressing a spin to the optical fiber are disclosed in the U.S. Pat. No. 5,298,047 and the U.S. Pat. No. 6,076,376.

### SUMMARY OF THE INVENTION

Accordingly, it is an object of the present invention to overcome the problems encountered in the conventional art.

It is another object of the present invention to provide an optical fiber drawing apparatus which is capable of minimizing a break of an optical fiber by adjusting a curvature radius of an optical fiber using at least one or more moving rollers and releasing a bending stress and stress concentration and is capable of decreasing a break of an optical fiber by adjusting an optical fiber curvature radius.

It is further another object of the present invention to provide an optical fiber drawing apparatus which is capable of impressing a spin to an optical fiber by reciprocating one among at least one or more moving rollers in a vertical direction with respect to a drawing surface of an optical fiber.

To achieve the above objects, the present invention provides an optical fiber drawing apparatus comprising a heating furnace adapted to melt an optical fiber mother material and to draw an optical fiber, an optical fiber standard value controller unit adapted to control standard values of the optical fiber drawn, a fixing roller adapted to change a drawing direction of the optical fiber, at least one or more moving rollers which are movable on a drawing surface for adjusting a curvature radius of the optical fiber which has a changed drawing direction, and a winding apparatus adapted to wind the optical fiber which has an adjusted curvature radius. Also, the present invention provides an optical fiber drawing apparatus impressing a spin to an optical fiber by reciprocating one among at least one or more moving rollers in a vertical direction with respect to a drawing surface of an optical fiber.

### BRIEF DESCRIPTION OF THE DRAWINGS

The present invention will be better understood with reference to the accompanying drawings.

FIG. 1 is a schematic view illustrating a conventional optical fiber drawing apparatus;

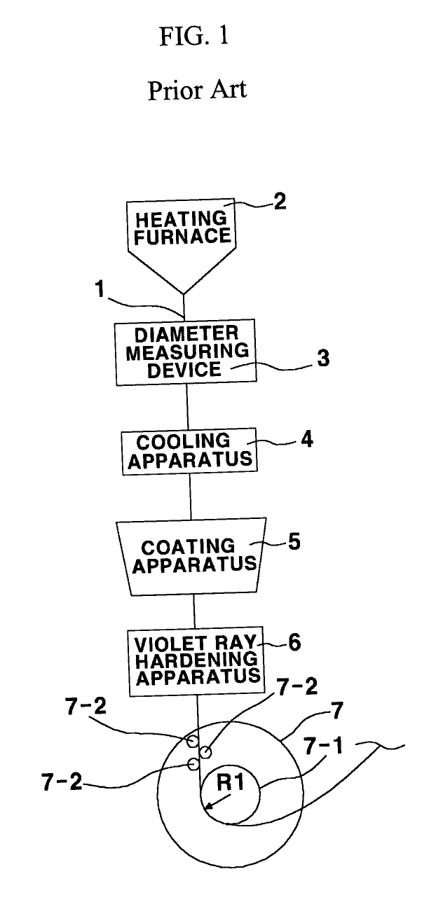

FIG. 2 is a schematic view illustrating a fixing roller unit of a conventional optical fiber drawing apparatus;

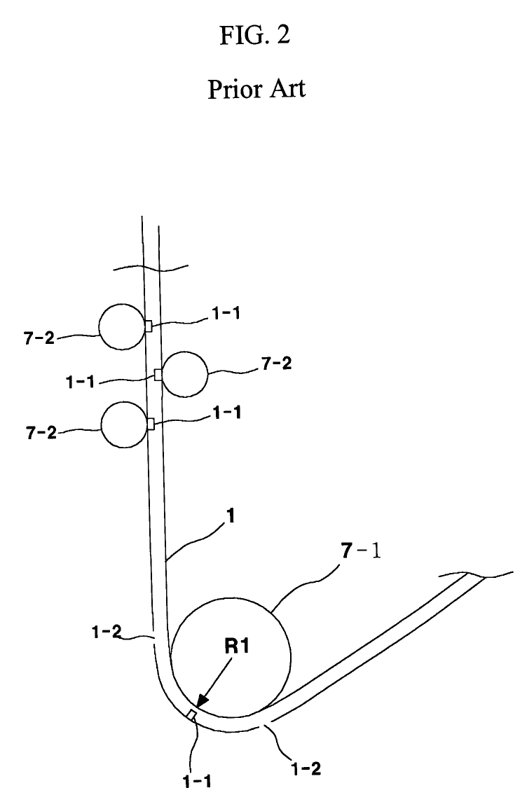

FIG. 3 is a schematic view illustrating an optical fiber drawing apparatus according to a first embodiment of the present invention;

FIG. 4A is a front schematic view illustrating a bracket of an optical fiber drawing apparatus according to a first embodiment of the present invention;

FIG. 4B is a lateral schematic view illustrating a bracket of an optical fiber drawing apparatus according to a first embodiment of the present invention;

FIG. 5 is a schematic view illustrating an optical fiber drawing apparatus according to a second embodiment of the present invention;

FIG. 6A is a front schematic view illustrating a bracket of an optical fiber drawing apparatus according to a second embodiment of the present invention; and

FIG. 6B is a lateral schematic view illustrating a bracket of an optical fiber drawing apparatus according to a second embodiment of the present invention.

### DETAILED DESCRIPTION OF THE PREFERRED EMBODIMENTS

The optical fiber drawing apparatus for decreasing an optical fiber break and impressing a spin to an optical fiber according to the present invention will be described with reference to the accompanying drawings.

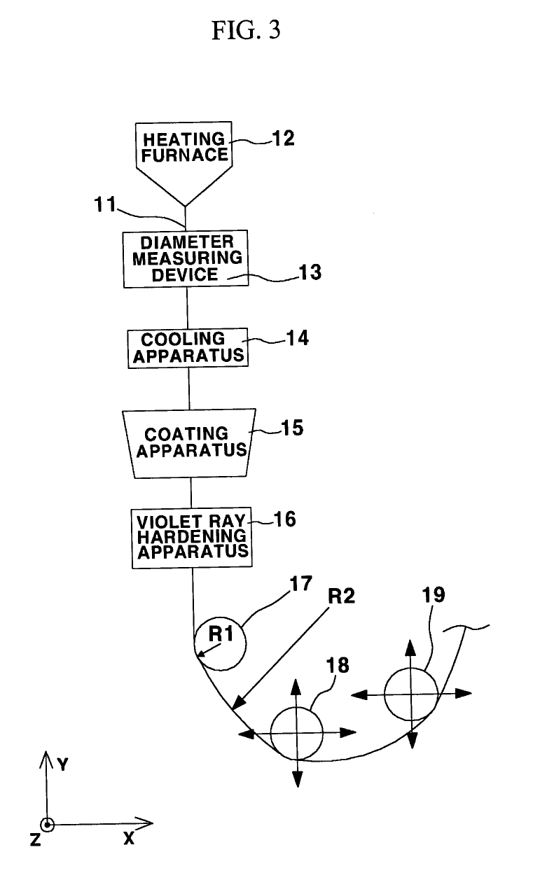

FIG. 3 is a schematic view illustrating an optical fiber drawing apparatus according to a first embodiment of the present invention.

In the optical fiber drawing apparatus for decreasing an optical fiber break and impressing a spin to an optical fiber according to the present invention, the fixing roller 17 and the moving rollers 18 and 19 may be installed by one of the following installation procedures.

In the optical fiber drawing apparatus according to the present invention, there are sequentially provided a heating furnace for melting an optical fiber mother material and drawing an optical fiber, a diameter measuring device for measuring a diameter of an optical fiber drawn from the heating furnace and controlling the same, a cooling apparatus for cooling an optical fiber which is heated by the heating furnace and has a high temperature, and a coating apparatus for coating the optical fiber after the optical fiber is cooled. At least one fixing roller is installed for changing a drawing direction of the optical fiber, and at least one or more moving rollers are installed after the fixing roller. And then there are provided a violet ray hardening apparatus for hardening an optical fiber, a capstan for adjusting the diameter measured by the diameter measuring device to a particular diameter, and a spool for winding the finished optical fiber.

As shown in FIG. 3, the optical fiber drawing apparatus according to the present invention comprises a heating furnace 12 for melting an optical fiber mother material and drawing an optical fiber 11, a diameter measuring device 13 for measuring and controlling the diameter of the optical fiber 11 drawn from the heating furnace, a cooling apparatus 14 for cooling the optical fiber which is heated by the heating furnace 12 and has a high temperature, a coating apparatus 15 for coating the optical fiber 11 after the optical fiber 11 is cooled, and a violet ray hardening apparatus 16 for hardening the optical fiber 11. At least one fixing roller 17 is provided for changing the direction of the optical fiber 11. At least one or more moving rollers 18 and 19 are continuously installed after the fixing roller 17. And then there are provided a capstan(not shown) for controlling the diameter measured by the diameter measuring device 13 to a particular diameter, and a spool (not shown) for winding the finished optical fiber.

Finally, in the optical fiber drawing apparatus according to the present invention, there are sequentially provided a heating furnace for melting an optical fiber mother material and drawing an optical fiber, a diameter measuring device for measuring and controlling a diameter of an optical fiber drawn from the heating furnace, a cooling apparatus for cooling the optical fiber which is heated by the heating furnace and has a high temperature, a coating apparatus for coating the optical fiber after the optical fiber is cooled, a UV hardening apparatus for hardening the optical fiber, and a capstan for controlling the diameter measured by the diameter measuring unit to a certain diameter. At least one fixing roller is installed for changing the direction of the optical fiber. At least one or more moving rollers are sequentially installed after the fixing roller. And then a spool is provided for winding the finished optical fiber.

As shown in FIG. 3, in the optical fiber drawing apparatus according to the above second installation procedure among the above three installation procedures, the adjusted curvature radius R2 according to the present invention is larger than the curvature radius R1 in which only the fixing roller is installed. Since the bending stress is in inverse proportion to the size of the radius R like σ_{b}=Ey/R, in the optical fiber drawing apparatus of the present invention, it is possible to decrease the bending stress applied to the optical fiber by increasing the curvature radius R2 which is adjusted using the fixing roller 17 and the moving roller 18 and 19.

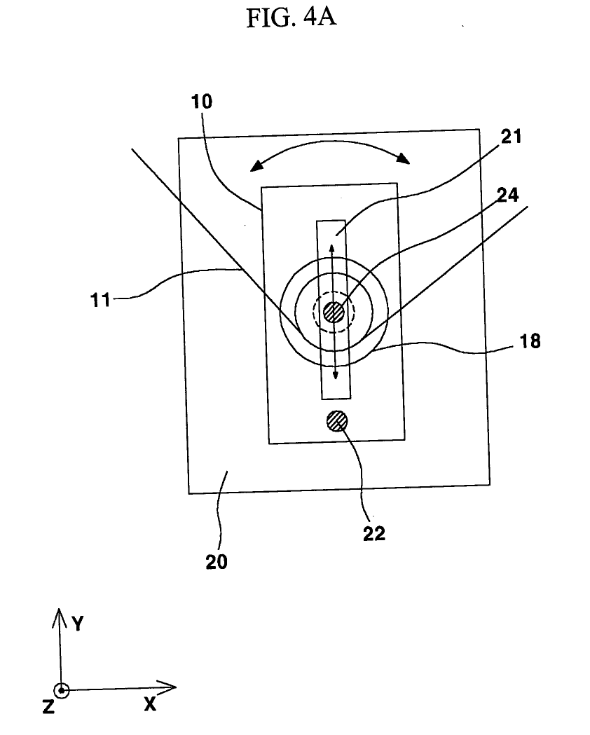

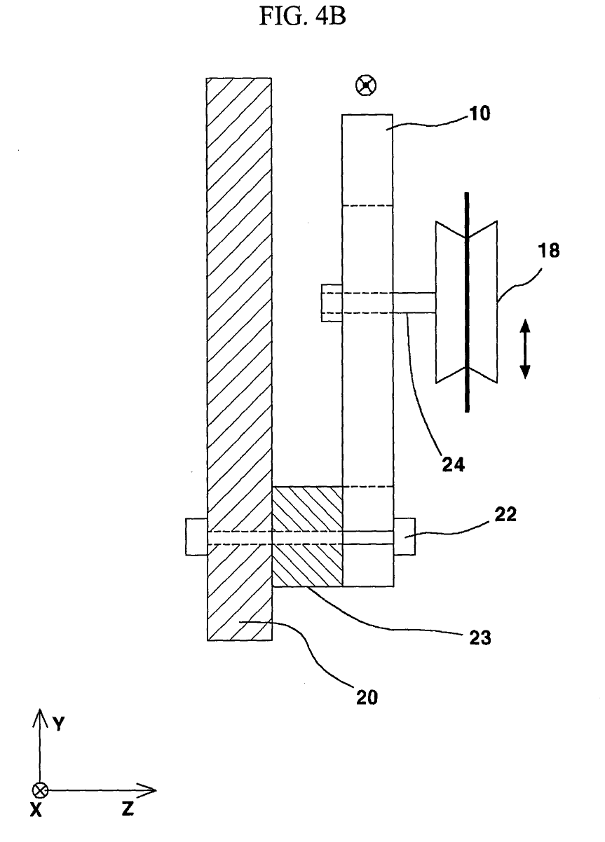

FIG. 4A is a front schematic view illustrating a bracket of an optical fiber drawing apparatus according to a first embodiment of the present invention.

As shown in FIG. 4A, there is provided a bracket 10 connected with the moving rollers 18 and 19 for moving the moving rollers 18 and 19 in the vertical and horizontal directions. The bracket 10 includes a vertical direction guide 21 installed in a longitudinal direction of the bracket 10, and a pivot joint 22 formed in one side of the bracket 10.

A shaft 12 of each of the moving rollers is installed along the vertical direction guide 21. A ball bearing (not shown) is installed between the shaft 12 of the moving roller and the moving roller for rotating the moving roller with respect to the shaft. As the roller shaft 12 is moved along the vertical direction guide 21, the moving rollers 18 and 19 of the present invention are reciprocated for thereby controlling the curvature radius of the optical fiber 11.

The pivot joint 22 is installed in one side of the bracket 10 for rotating the bracket 10 in a horizontal direction on a reciprocating movement. Therefore, the moving rollers 18 and 19 of the present invention control the curvature radius during the direction change of the optical fiber 11 based on the movement of the bracket 10 which is rotated with respect to the pivot joint 22.

Here, it is possible to measure the average strength value of the optical fiber 11 based on an experiment. In the present invention, it is possible to control the curvature radius of the optical fiber 11 during the direction change when the optical fiber 11 is drawn in such a manner that the moving rollers 18 and 19 are moved in the vertical and horizontal directions in order to prevent the bending force from being applied to the optical fiber 11.

FIG. 4B is a lateral schematic view illustrating the bracket of the optical fiber drawing apparatus according to a first embodiment of the present invention.

As shown in FIG. 4B, one side of the bracket 10 of the optical fiber drawing apparatus according to the present invention is connected with the tower body 20 by the pivot joint 22. The pivot joint 22 is engaged in such a manner that the bracket 10 is rotated with respect to the pivot joint.

Since the tower body 20 supports the optical fiber drawing apparatus, as the vibration of the tower body 20 is increased, a larger amount of vibrations are transferred to the optical fiber in the optical fiber drawing process, so that it is impossible to fabricate a circular symmetrical optical fiber. As shown in FIG. 4B, a spacer 23 is installed between the bracket 10 and the tower body 20 in such a manner that the vibrations occurring in the bracket 10 are not transferred to the tower body 20. The spacer 23 is formed of a material which is capable of decreasing a mechanical vibration.

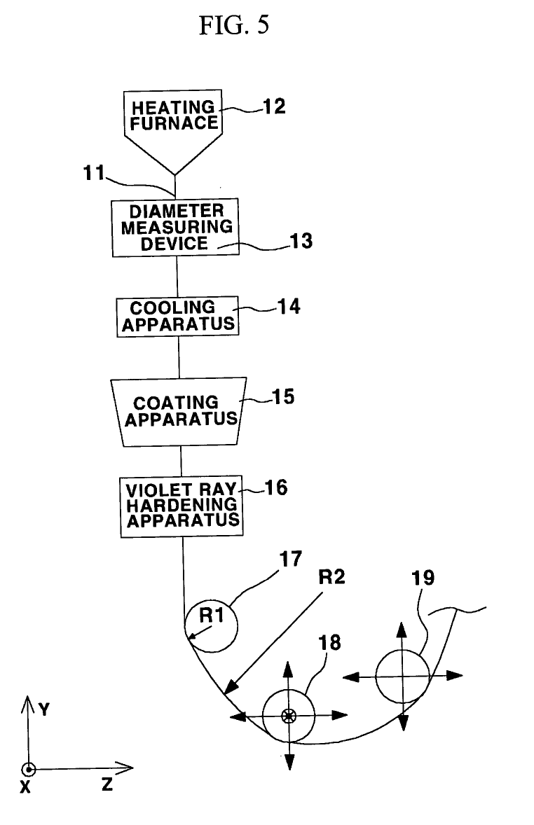

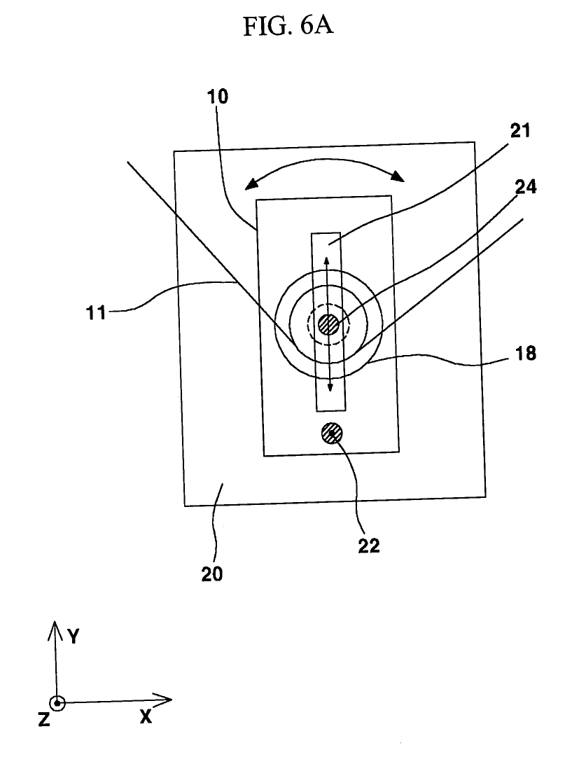

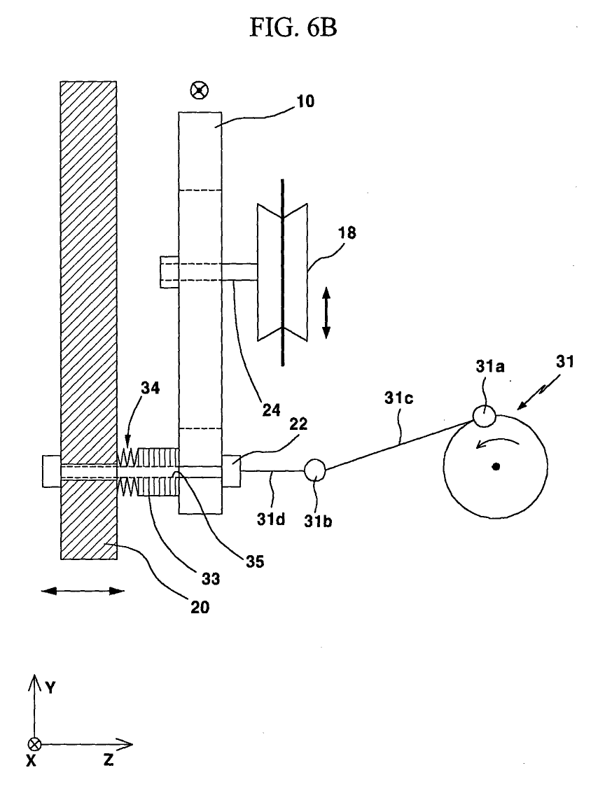

FIGS. 5 through 6B are views illustrating an optical fiber drawing apparatus according to a second embodiment of the present invention. The optical fiber drawing apparatus according to the second embodiment of the present invention further comprises an optical fiber spin impressing apparatus in the optical fiber drawing apparatus compared to the optical fiber drawing apparatus of the first embodiment of the present invention.

FIG. 5 is a schematic view illustrating the optical fiber drawing apparatus according to the second embodiment of the present invention.

As shown therein, an apparatus is installed in one moving roller 18 among the moving rollers 18 and 19 according to the preferred embodiments of the present invention for impressing a spin to the optical fiber. The moving roller 18 reciprocates in the vertical direction with reference to a drawing surface of the optical fiber. Therefore, the optical fiber is formed in a certain wave shape having a certain amplitude and wavelength in the direction vertical to the drawing surface. As a result, the moving roller 18 applies a certain spin to the optical fiber during the drawing procedure of the optical fiber.

FIG. 6A is a front schematic view illustrating a bracket of the optical fiber drawing apparatus according to a second embodiment of the present invention.

An apparatus adapted for impressing a spin to the optical fiber is connected with the pivot joint 22 of FIG. 6A, so that the spin impressing apparatus is driven in the direction vertical to the drawing surface of the optical fiber. Namely, in the case that the optical fiber spin impressing apparatus is connected with the pivot joint 22, the connection portion of the spin impressing apparatus connected with the pivot joint 22 is not affected by the rotation of the bracket by the pivot joint 22. Therefore, the spin impressing apparatus may be driven in only the direction vertical to the drawing surface of the optical fiber.

FIG. 6B is a lateral schematic view illustrating a bracket of the optical fiber drawing apparatus according to a second embodiment of the present invention.

The optical fiber drawing apparatus according to the second embodiment of the present invention includes one moving roller 18 which capable of impressing a spin to the optical fiber among a plurality of moving rollers 18 and 19. The apparatus for impressing a spin to the optical fiber 11 according to the second embodiment of the present invention is a CAM driving apparatus 31. As known to persons who are skilled in the art, the CAM driving apparatus 31 is capable of converting a rotational movement into a linear movement. Namely, the CAM driving apparatus rotates and is capable of reciprocating linearly the apparatus connected with the CAM driving apparatus.

As shown in FIG. 6B, the CAM driving apparatus 31 includes a first link line 31c, a second link line 31d, a first link 31a, and a second link 31b for transferring a movement of the CAM driving apparatus. The first link 31a is adapted to connect the rotation movement portion of the CAM driving apparatus to the first link line 31c, and the second link 31b is adapted to connect the first link line 31c to the second link line 31d.

An elastic unit 33 is installed between the tower body 20 and the bracket 10 in order for the CAM driving apparatus 31 to move the bracket 10. Also, the elastic unit 33 prevents a transfer of a vibration occurring in the bracket 10. Preferably, a spring 34 having a certain recovering force is installed between the tower body 20 and the elastic unit 33. The spring 34 supports the recovering operation of the CAM apparatus. The diameter of the hole of the tower body 20 is larger than the diameter of the CAM guide 35 for thereby implementing a smooth operation of the CAM guide 35.

The CAM driving apparatus 31 according to the second embodiment of the present invention is adapted to rotate the first link 31a. The rotation of the first link 31a is transferred to the second link 31b through the first link line 31c and is continuously transferred to the second link line 31d. Therefore, the second link line 31d reciprocates, so that the bracket 10 reciprocates. The CAM driving apparatus 31 drives the moving roller 18 in a direction vertical to the drawing surface of the optical fiber based on the reciprocating movement of the bracket 10 during the drawing procedure of the optical fiber, so that a spin is periodically applied to the optical fiber 11. The spin applied to the optical fiber may be controlled by changing the driving rate of the CAM driving apparatus 31 according to the present invention.

In another preferred embodiment of the present invention, a certain number n(n=1, 3, 4, 5, 6 . . . ) of the brackets 10 adapted to reciprocate the moving rollers may be continuously provided after the fixing roller.

As described above, it is possible to decrease a bending stress and stress concentration which occur during the drawing process by increasing the curvature radius on the drawing surface of the optical fiber and to decrease the stress concentration due to a micro particle or crack for thereby decreasing the break of the optical fiber. In addition, it is possible to decrease the polarization mode dispersion (PMD) which may occur during the transfer of the signal in the optical fiber by impressing a spin to the optical fiber. In addition, it is possible to enhance a safety with respect to the vibration in such a manner that moving rollers are additionally provided compared to the case that only fixing roller is provided for a high speed drawing process.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An optical fiber drawing apparatus, comprising:
a heating furnace adapted to melt an optical fiber mother material and to draw an optical fiber;
an optical fiber standard value controller unit adapted to control standard values of the optical fiber drawn;
a fixing roller adapted to change a drawing direction of the optical fiber;
at least one or more moving rollers which are movable on a drawing surface for adjusting a curvature radius of the optical fiber which has a changed drawing direction; and
a winding apparatus adapted to wind the optical fiber which has an adjusted curvature radius.

2. The apparatus of claim 1, wherein there is provided a bracket connected to said at least one or more moving rollers, respectively, in order for said at least one or more moving rollers to move along a drawing surface of the optical fiber.

3. The apparatus of claim 2, wherein said bracket comprises a vertical direction guide in which grooved in a vertical direction and which a shaft of each of at least one or more moving rollers is embedded and in order for said at least one or more moving rollers to reciprocate in a vertical direction.

4. The apparatus of claim 3, wherein a pivot joint is installed in one side of the bracket, and the bracket rotates about the pivot joint.

5. The apparatus of claim 2, further comprising an apparatus capable of impressing a spin to the optical fiber by reciprocating the bracket in a vertical direction with respect to a drawing surface of the optical fiber, said apparatus being connected with a bracket connected to one among at least one or more moving rollers.

6. The apparatus of claim 5, wherein said apparatus adapted to impress a spin to the optical fiber is a link connected CAM.

7. The apparatus of claim 1, wherein said optical fiber standard value controller unit comprises:
an optical fiber diameter controller unit adapted to measure and control the diameter of the optical fiber; and
an optical fiber fabricating unit adapted to process an optical fiber that the diameter of the same is measured.

8. The apparatus of claim 7, wherein said optical fiber diameter controller unit comprises:
a diameter measuring device adapted to measure a diameter of an optical fiber drawn from the heating furnace; and
a capstan adapted to draw an optical fiber having a particular diameter with respect to the diameter measured.

9. The apparatus of claim 7, wherein said optical fiber fabricating unit comprises:
a cooling apparatus adapted to cool the optical fiber melted in the heating furnace;
a coating apparatus adapted to coat the cooled optical fiber with a certain coating material; and
a violet ray hardening apparatus adapted to harden the optical fiber coated.
